(19) United States
(12) Patent Application Publication
(10) Pub. No.: US 2024/0283324 A1
(43) Pub. Date: Aug. 22, 2024

(54) MULTI PLATE RELUCTANCE MOTOR

(71) Applicant: ELTORQUE AS, Trondheim (NO)

(72) Inventor: Jon Eirik BRENNVALL, Trondheim (NO)

(21) Appl. No.: 18/571,301

(22) PCT Filed: Jun. 17, 2022
(86) PCT No.: PCT/NO2022/050139

§ 371 Date: Dec. 18, 2023

(30) Foreign Application Priority Data
Jun. 17, 2021 (NO) 20210788

(51) Int. Cl. H02K 7/08; H02K 1/12; H02K 1/24

(52) U.S. Cl. CPC H02K 7/08; H02K 1/12; H02K 1/246

(57) ABSTRACT

A reluctance motor is presented. The reluctance motor comprises a rotor and a stator, where the stator comprises two end stators and at least one stator mid plate (4, 23) with stator mid plate teeth (13, 23A, 23B), and the rotor comprises at least two rotor plates (3, 22) with rotor plate teeth (14, 22A, 22B). The at least one stator mid plate (4, 23) and the at least two rotor plates (3, 22) are arranged between the two end stators (1, 21).

### FIELD OF THE INVENTION

The presented invention generally relates to reluctance motors and more particularly relates to a variant of the castellated variable reluctance motor.

The reluctance motor is a class of electric motor where rotor is made from ferromagnetic materials only. If the rotor comprises coils, squirrel-cage or magnets, in addition to the ferromagnetic material, the motor will belong to other motor classes like permanent magnet motors, induction motors, slip ring motors etc. It is desirable to make the rotor in reluctance motors of laminated steel, since any current in rotor will reduce motor efficiency.

The rotor in reluctance motors has teeth. The stator comprises “electromagnets” that pull on the teeth. The electromagnets are turned on and off in sequence to create pull on the rotor in the same directions at all positions. The explanation is a bit simplified, but it is useful to understand the principle. Unlike permanent magnet (PM) motors the electromagnets in a reluctance motor cannot push on the rotor. They can only pull. This means that a reluctance motor needs at least 3 phases for the stator to be able to produce torque on the rotor in all positions.

### BACKGROUND OF THE INVENTION

The motor according to the invention is called a multi plate reluctance motor. This is to distinguish this motor from the multidisc (or multistage) motor. The multidisc motor is well known. Aydin et. al has in research report “Axial Flux Permanent Magnet Disc Machines: A Review” from 2004 shown a classic PM multi disk motor design. Multidisc induction motors have also been investigated.

One way of increasing torque from an axial flux PM motor is to increase length of the motor. However, if the diameter is kept constant and the length of the magnets and coils is increased in such a motor the leak field will increase. At some point the leak field gives bad utilisation of the materials. Then it is better to place several motors in a line and let them share shaft, but then a back iron is still required to turn direction of the magnetic field within each motor.

In multidisc motors you take away the back iron between the motors and let the magnetic field go in the same direction through all the motors. Then the magnetic field change direction first in the end of the stack of motors. This reduces the total length considerably because several back iron between the motors are taken away.

However, the magnets and the coils still have the same thickness as in the original motor. There is no theoretical limitation to the length of a multidisc motor. Multidisc motors do not have to be PM motors. Induction motors and several other types of electric motors can also be multidisc motors.

In an axial flux multi plate variable reluctance motor there most commonly only are coils in the stators at each end of the motor. Between the end stators alternating rotor plates and stator mid plates are stacked. This amplifies the torque because the magnetic field zigzag between the rotor plates and the stator mid plates. From an electromagnetic point of view, the rotor plates and stator mid plates can be very thin. Manufacturing methods and structural integrity limit the thickness of the plates. The more plates that are stacked, the more magnetomotive force you need to drive the magnetic field through all the plates. The leak field as the stack thickness increases. These effects provide a theoretical limitation to how many plates that can be stacked in a multiplate reluctance motor. It is only reluctance motors that can be multiplate motors. For further description reference is made to the “Detailed description of the invention”.

### Introduction to Reluctance Motors

As mentioned, a reluctance motor needs at least 3 phases for the stator to be able to produce torque on the rotor in all positions. The simplest possible reluctance motor is shown in FIG. 0A. The drawing is taken from Wikipedia™, but arrows [M] that indicate direction of the magnetic field, arrow [R] that indicate rotation direction of rotor and [PA], [PB] and [PC] that indicate phase A, phase B and phase C have been added. In the rotor position shown it is only current in phase A. Current direction in the coil is indicated by arrow [C1] (out of the plane) and arrow [C2] (into the plane). The rotor must rotate 15 mechanical degrees before current in phase C is turned on and 30 mechanical degrees before current in phase A is turned off. Rotor must rotate another 45 mechanical degrees before current in phase A is turned on again. The current is therefore only a half sinus in a reluctance motor. The current can be alternated in the phases every time it is turned on, but there is no benefit in doing so.

The magnetic field in a reluctance motor needs to go in a loop, so each phase in a reluctance motor should have at least 2 coils. 1 coil per phase is possible due to leak field, but it is very inefficient. An example of 1 coil per phase can be found in patent EP1280262A2. 3 coils per phase will give a motor where the field that goes through 2 coils must return through 1 coil. It is similar for 5 or 7 coils per phase. 1, 3, 5, 7 . . . coils per phase is therefore possible but give suboptimal motors. 4, 6, 8 etc. coils per phase is the pattern for 2 coils per phase repeated.

The design in FIG. 0A is 3 phased. 3 phased means that coils belonging to the same phase have the same current as function of time. Coils belonging to different phases have different current as function of time. For a 3 phased PM-motor the current is shifted ⅔*pi. Assuming the current in the phases are sinusoidal, this means the current in the phases are:
phase A: IA=I₀*sin(θ_{E})
phase B: IB=I₀*sin(θ_{E}+2π/3)
phase B: IC=I₀*sin(θ_{E}+4π/3)

I₀ is max current in the coils. θ_{E} is the electrical angle. In most electric motors 2*π electrical degrees is defined as the shortest mechanical angle the rotor must rotate for the positions to be identical. For the motor shown in FIG. 0A the θ_{E}=¼θ_{M} because rotor must move ¼ of one full mechanical rotation to complete one full electrical cycle. θ_{M}=mechanical angle. π=pi=3.14159 . . . .

A weakness of the 3 phased reluctance motor is torque ripple. This has partly to do with coil configuration. Below it is explained why.

In a 3 phased permanent magnet (PM) motor torque from one phase is proportional with sin(θ_{E})². Sinus squared, because:
1) Torque as function of electrical angle is (more or less) sinusoidal if the current in the phase is constant.
2) The current in the phases is (usually) sinusoidal.

It turns out that sin(θ_{E})²+sin(θ_{E}+2π/3)²+sin(θ_{E}+4π/3)²=constant (=1,5). This means that a properly designed 3 phased PM motor can have zero torque ripple if fed with 3 phased sinusoidal current that is 2π/3 radians (120°) shifted. This makes such a motor well suited as generator on the electric grid.

For a two phased PM motor the current between the phases is shifted π. Again, torque from one phase is proportional with sin(θ_{E})² and again it tourns out that sin(θ_{E})²+sin(θ_{E}+π)²=constant (=1). This means that a properly designed 2 phased PM-motor also can have zero torque ripple if fed with 2 phased sinusoidal current that is π radians (180°) shifted.

However, for a 3 phased reluctance motor you skip the negative part of the current. This means that the torque from each phase is proportional to:
Phase A: IF sin(θ_{E})>0 THEN torque ˜sin(θ_{E})² ELSE torque=0
Phase B: IF sin(θ_{E}+2π/3)>0 THEN torque ˜sin(θ_{E}+2π/3)² ELSE torque=0
Phase C: IF sin(θ_{E}+4π/3)>0 THEN torque ˜sin(θ_{E}+4π/3)² ELSE torque=0

The sum of this is not constant. (It is almost proportional to 0.75-0.25*sin(3*θ_{E}).) Therefore a 3 phased reluctance motor will have serious torque ripple if fed with the positive part of a sinusoidal current. Torque ripple means noise, which is why the reluctance motor is not very popular.

Advanced current control can reduce the torque ripple, but the current will then consist of high frequency components that also creates problems.

In the 4 phased reluctance motor the torque from each phase are:
Phase A: IF sin(θ_{E})>0 THEN torque ˜sin(θ_{E})² ELSE torque=0
Phase B: IF sin(θ_{E}+π/2)>0 THEN torque ˜sin(θ_{E}+π/2)² ELSE torque=0
Phase C: IF sin(θ_{E}+2π/2)>0 THEN torque ˜sin(θ_{E}+2π/2)² ELSE torque=0
Phase D: IF sin(θ_{E}+3π/2)>0 THEN torque ˜sin(θ_{E}+3π/2)² ELSE torque=0

The sum of this is constant (=1). If you add phase A+C and phase B+D you see it is the same as a two phased PM-motor. This means it is possible to make a 4 phased reluctance motor with zero torque ripple if fed with sinusoidal current.

It can be shown by similar reasoning that a 6 phased reluctance motor also can have zero torque ripple if fed with sinusoidal current. 8 phases are two 4 phased motors. 10 phases are a 4 phased and a 6 phased motor. It can therefore be shown that any reluctance motor with pair number of phases larger than 4 can have zero torque ripple.

Another issue when it comes to torque ripple is magnetic saturation of the iron. Once the iron in the motor starts to become saturated the maximum current (e.g., when θ_{E}=π/2 in phase A) produce torque less effective. The torque as function of θ_{E} is therefore not proportional with the current. Therefore, a motor that has zero torque ripple at a given sinusoidal current can be designed. However, if you decrease the current below the design current you get torque ripple again. Variable reluctance motors will therefore make more noise than other motors at idle. The same effect makes it impossible to design motors with zero torque ripple when the saturation becomes high enough.

In this patent application castellated variable reluctance motors (CVRM) is of particular interest, but it also applies to all reluctance motors, since a CVRM with 1 tooth per coil technically is a normal reluctance motor shown in FIG. 0A.

CVRM is described in the patent applications EP2671309A1 and EP2885855A1. Sargos et. al. has published a paper named “Generalized theory of the structure of reluctance stepper motors” in 1993.

For a reluctance motor to be castellated there must be at least two teeth under each coil. The teeth under each coil are evenly distributed with the same distance between the teeth as in the rotor. The gap between adjacent teeth under different coils must be larger or smaller than the gap between the rotor teeth. For the motor to be symmetrical all gaps between adjacent teeth under different coils must be equal.

For 3 phased reluctance motors with two coils per phase the number of teeth in stator is 6n in symmetrical designs. Possible number of teeth in the rotor is 6n±2+6m. n is a positive integer. m is a positive integer or zero. In general, 6n−2 teeth in rotor gives the best motor designs, but if number of teeth is large you might choose 6n+2 or 6n−2+6 to get sufficient space for using a needle winder to wind the coils. As mentioned, 3 phases do not give constant torque if the current is sinusoidal. A 3 phased reluctance motor will therefore make a lot of noise.

For 4 phased reluctance motors with two coils per phase number of teeth in the stator is 8n in symmetrical designs. Possible number of teeth in rotor is 8n−2+4m. Again 8n−2 teeth in rotor gives the best motor designs, but if the number of teeth is large you might choose 8n+2 or 8n+6 to get sufficient space for using a needle winder to wind the coils.

In general, the number of teeth in rotor in symmetric designs are:

nTeeth=Phases*Coils per Phase*Teeth per coil±(±1+Phases*m)*Coils per Phase

### SUMMARY OF THE INVENTION

An aspect of the invention is a reluctance motor comprising a rotor and a stator, the stator comprising two end stators. The stator comprises further at least one stator mid plate with stator mid plate teeth, and the rotor comprises at least two rotor plates with rotor plate teeth. The at least one stator mid plate and the at least two rotor plates are arranged between the two end stators providing for zigzagging of magnetic field between the at least two rotor plates and the at least one stator mid plate, thus amplifying torque of the reluctance motor.

Optionally, the reluctance motor comprises needle bearings for axial thrust arranged as spacers between at least two adjacent parts of the reluctance motor, where the parts comprise the end stators, the stator mid plates, and the rotor plates, ensuring spacing between the adjacent parts.

Optionally, the reluctance motor comprises fluid bearings for axial thrust arranged as spacers between at least two adjacent parts of the reluctance motor, where the parts comprises the end stators, the stator mid plates and the rotor plates, ensuring spacing between the adjacent parts.

Optionally, the reluctance motor comprises bearing balls, where the rotor plates, the end stators and the stator mid plates are arranged with tracks for the bearing balls so the bearing balls can ensure distance between end stators, stator mid plates, and the rotor plates, preventing them from touching each other.

Optionally, the number of phases of the reluctance motor is an even number equal to or greater than 4, and where the number of phases is halved by diodes arranged to steer the current into different phases depending on the direction of the current.

Optionally, the end stator teeth, stator mid plate teeth and/or rotor plate teeth have one of the following shapes: chamfered, filleted and sinusoidal.

### DESCRIPTION OF THE FIGURES

Embodiments of the present invention will now be described, by way of example only, with reference to the following figures, wherein:

FIG. 0A shows a reluctance motor according to state of the art.

FIG. 1 shows a cross section of a linear reluctance motor according to the invention.

FIG. 2 shows the linear reluctance motor in FIG. 1 from above.

FIG. 3 corresponds to FIG. 1 without hatching, but with indication of magnetic path and current direction.

FIG. 4 shows the magnetic field to illustrate the purpose of the stator mid plates.

FIG. 5 shows the magnetic field and current in a motor of limited length.

FIG. 6 corresponds to FIG. 5, but with a motor of unlimited length.

FIG. 7 shows two 3 phased motor configurations.

FIG. 8 shows a reluctance motor where the multiplate system is integrated in a multidisc system.

FIG. 9 indicates how a linear reluctance motor can be bent to get a radial flux motor.

FIG. 10 indicates how a linear reluctance motor can be bent to get an axial flux motor.

FIG. 11 shows a detailed view of FIG. 1.

FIG. 12 shows a multiplate axial flux CVRM in an exploded view.

FIG. 13 shows an assembled version of the motor presented in FIG. 12.

FIGS. 14, 14A and 14B show cross sections of the motor presented in the FIGS. 12 and 13.

FIG. 15 shows a 6-phased version of the reluctance motor connected to a 3 phased grid in a delta configuration.

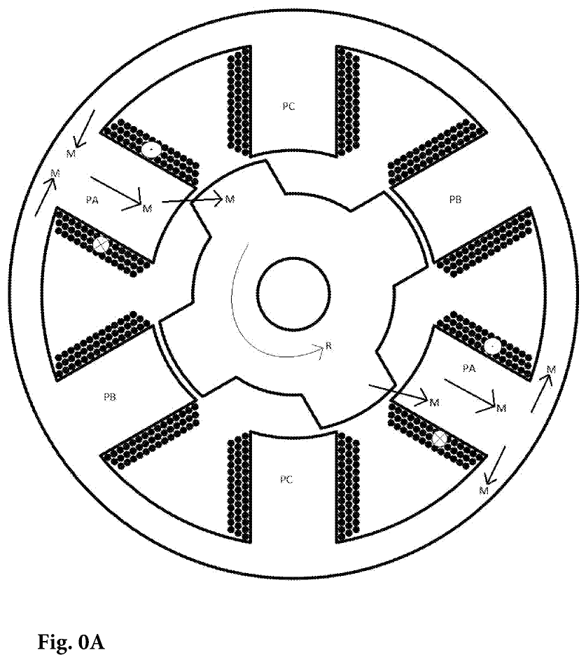

### LIST OF REFERENCE NUMBERS IN THE FIGURES

The following reference numbers refer to the drawings:
Number Designation
1A-C Stator
2 Coil
2A-D Coils for phase A-D
3 Rotor plate
4 Stator mid plate
5 Arrow indicating direction of rotor plate movement
6 Arrow indicating magnetic path
7 Arrow indicating current direction into the plane
8 Arrow indicating current direction out of the plane
9 Arrow indicating magnetic field zigzagging
10 Arrow indicating direction of a bending force
11 Arrow indicating direction of a bending force
12, 12A Teeth in the stator
13, 13A-C Teeth in the stator mid plate
14, 14A-C Teeth in the rotor plate
21 End stator
21A-21B Teeth on the stator
22 Rotor plate
22A-22B Teeth on the rotor plate.
23 Stator mid plate
23A-B Stator mid plate teeth
23C Track
24 Coil
24A-D Coils for phase A-D
25 Shaft
26 Bearing
27 Needle bearing
28 Pathway for needle bearing

### DESCRIPTION OF PREFERRED EMBODIMENTS OF THE INVENTION

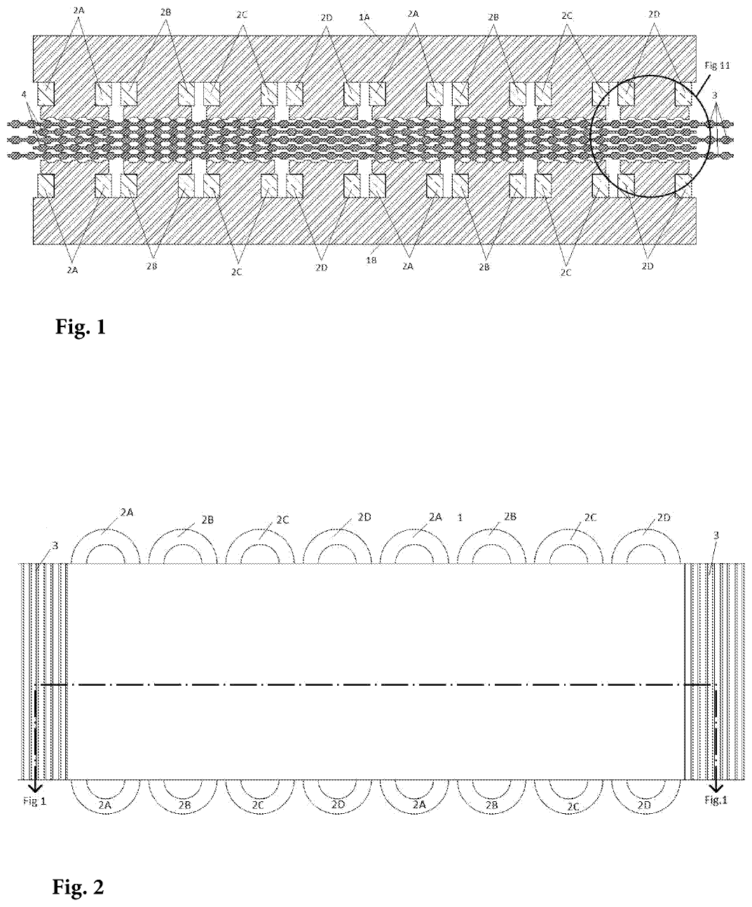

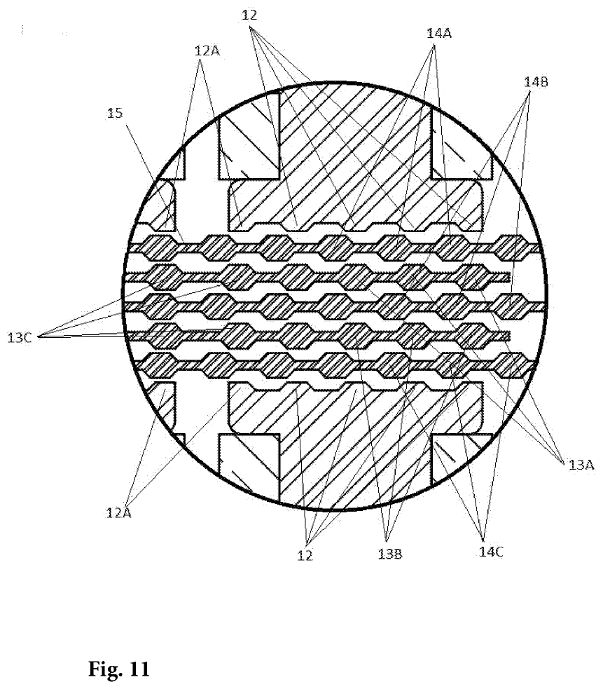

This invention relates to reluctance motors including linear reluctance motors, radial reluctance motors and axial flux reluctance motors. First a description of an embodiment of the invention as a linear reluctance motor is shown in FIG. 1, that presents a cross section of the motor. This is a 4 phased linear CVRM with 2 coils in each phase where n is 5 and m is 1. In a normal CVRM it would be 1 rotor plate [3] between two stators [1]. The motor in FIG. 1 has 3 rotor plates [3] and 2 stator mid plates [4] have been added. The teeth in the stator mid plate [4] have the same configuration as the teeth in the stator [1]. The rotor plates [3] have teeth where the spacing between the teeth is equal. The teeth are given reference numbers in FIG. 11.

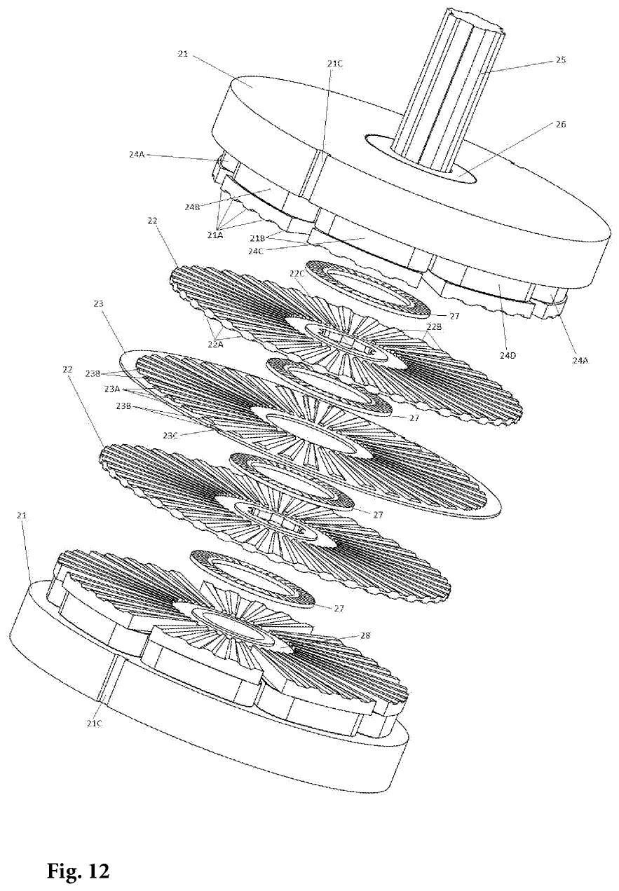

The cross section presented in FIG. 1 is the same all the way through the linear motor. This makes it easier to understand the design and how the motor works, also for the axial design shown in FIGS. 12 to 14. If the motor is made of laminated steel each plate in the lamination will have the same shape as the stator [1], the rotor plate [3] and the stator mid plate [4]. This means that in the linear motor all the lamination has the same shape, something which is practical if the lamination is manufactured by punching.

FIG. 2 shows the motor from above. Here it can be seen how the coils [2] are connected. Coils marked [2A] belong to phase A, coils marked [2B] belongs to phase B and so on. The dotted line indicates the cross section in FIG. 1.

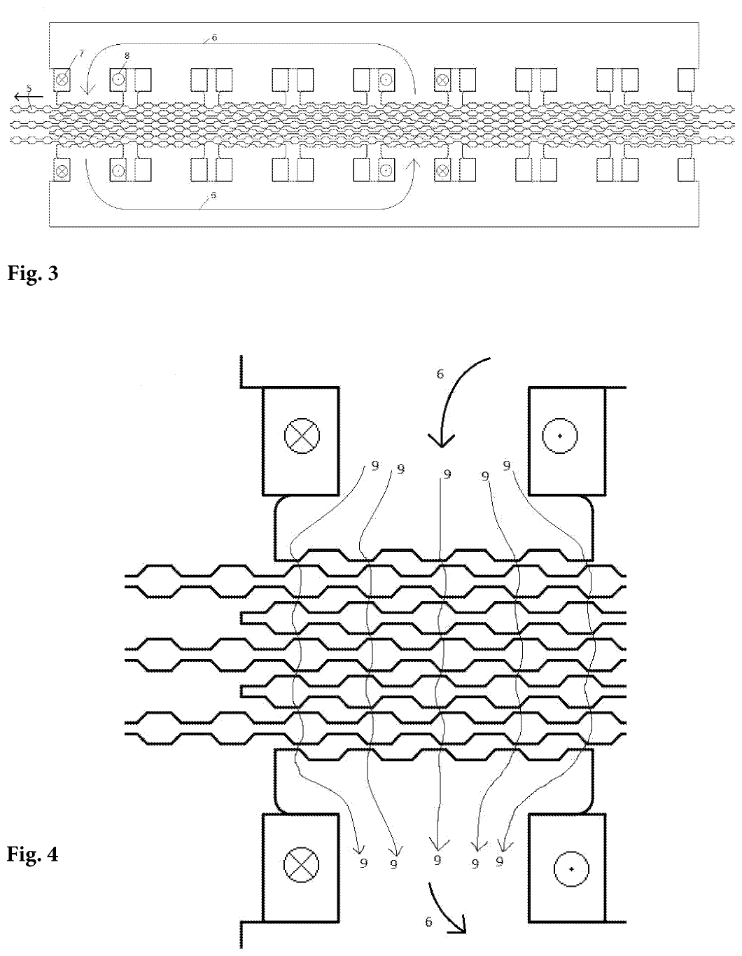

FIG. 3 corresponds to FIG. 1 without hatching. In FIG. 3 the magnetic path in the entire motor is indicated by arrow [6]. Arrow [7] (into the plane) indicate current direction in the coil. So does arrow [8] (out of the plane). Arrow 5 indicates in which direction the rotor plates move.

The purpose of the stator mid plates [4] is shown in FIG. 4. Here it is shown how the magnetic field indicated by arrows [6] split up indicated by arrows 9. Arrow 9 also indicate how the magnetic field zigzag through the rotor plates [3] and stator mid plates [4], creating torque every time it passes a rotor disk [3]. Those familiar with reluctance motors will notice that the side of the teeth in FIG. 4 is not straight. The teeth are chamfered. The reason for the chamfering is to reduce the saturation at the bottom of the tooth. This increases the torque the motor can produce considerably.

The angle of the chamfer can vary. In an alternative embodiment the chamfers are curved. In alternative embodiments the chamfers are replaced by fillets, or the entire teeth structure is given a sinusoidal shape. A lot of different embodiments are possible. Whether or not they are beneficial must be determined through numerical simulations or experiments.

The chamfering together with slot depth between the teeth and sloth width relative to the tooth width are parameters that control the torque ripple.

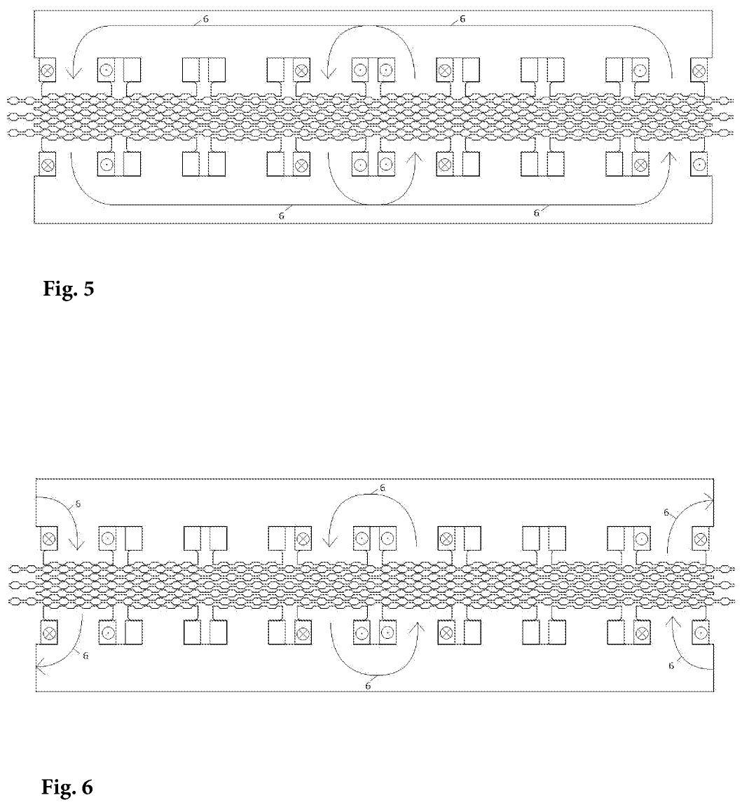

FIG. 5 shows the current and the magnetic field [6] in FIG. 1 when there is current in 2 coils. This is for a motor of limited length. If the motor has unlimited length or is bent into a ring, the magnetic field [6] will be as shown in FIG. 6.

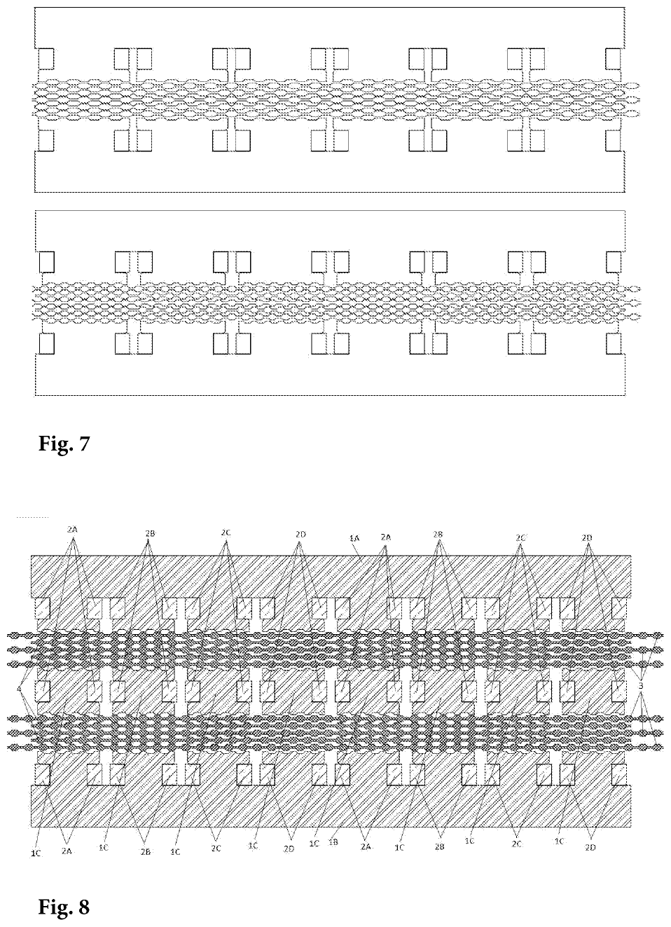

FIG. 7 shows two 3 phased motor configurations. The motor at the top has configuration n=5 and number of teeth in rotor is 6n−2. The motor at the bottom has configuration n=7 and number of teeth in rotor is 6n+2 to get more space between the coil slots.

FIG. 8 indicates how the reluctance motor multi plate system can be integrated in a multidisc system. Here there are 3 stators [1A], [1B] and [1C] where [1C] is the one in the middle. As for other multidisc motors it is possible to include many middle stators.

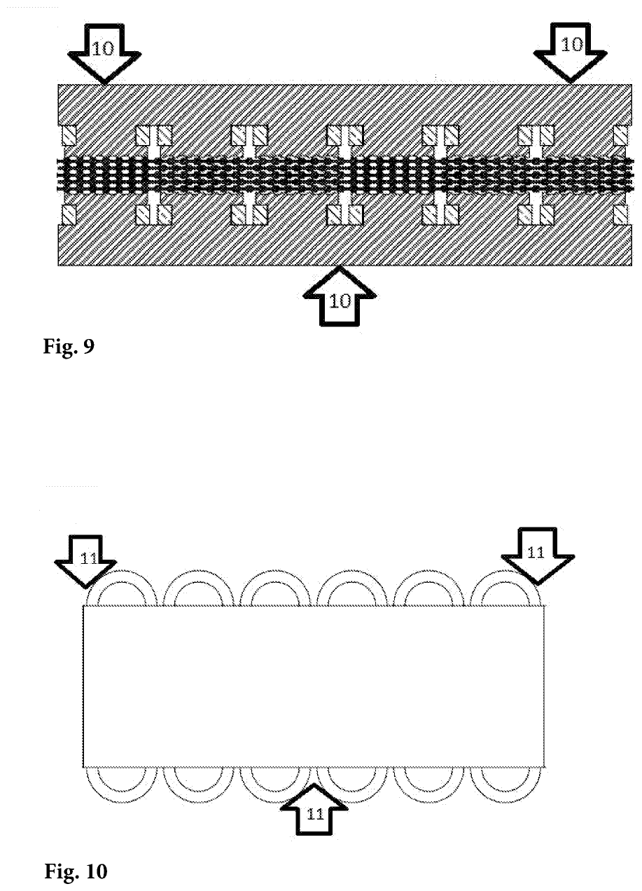

FIG. 9 indicates how the linear motor can be bent to get a radial flux motor. Arrow (10) indicates a bending force. In a radial flux motor, the lamination is perpendicular to the shaft and has the same shape all the way through the motor. It can also be simulated in 2D. However, a multiplate radial flux motor is probably more complicated to assemble than an axial flux motor.

FIG. 10 indicates how the motor can be bent to get an axial flux motor. Arrow (11) indicates a bending force. In an multiplate axial flux reluctance motor the lamination is cylindrical shell with centre in the shaft. Making lamination for an axial flux motor is therefore more complicated.

Bending a linear motor is probably not the best manufacturing method. FIGS. 9 and 10 therefore only give a general idea about how a linear motor can be transformed into a radial flux motor or an axial flux motor.

FIG. 11 presents a close up of FIG. 1 highlighted by a ring in the last-mentioned figure.

FIG. 12 is an exploded view of a multiplate axial flux CVRM. 21 is the end stator, 22 is the rotor plates, 23 is the stator mid plate (only one in this figure) and 24 is coils. 21A and 21B are teeth on stator. 21B indicates adjacent teeth under different coils [24B] and [24C]. [22A] and [22B] indicate rotor teeth on each side of the rotor plate [22].

It is critical for the torque that the air gap (the distance between rotor and stator disks) is as little as possible. Needle bearings [27] are therefore used as spacers between stator and rotor disks. Another solution to keep the air gap small, is to fill the gaps between the teeth with epoxy or other insulation material that is not ferromagnetic. A fluid bearing can then be incorporated to keep the rotor disks apart. It is also possible to make one or more tracks for bearing balls in the rotor plates and stator mid plates. Both the fluid bearing and the tracks for bearing balls will prevent the relative thin rotor plates and stator mid plates from vibrating or bending do to electromagnetic forces.

This way it can be ensured that the tolerances do not add up the way it would do if spacers were used between the rotor disks. The shaft [25] must have a shape so the rotor plates [22] transfer torque to the shaft and keep their position relative to the other rotor plates [22]. FIG. 12 shows a spline shaft, but a shaft with slot and key is also possible. With this design the shaft can move in axial direction and does not influence the distance between rotor plates and stator plates.

[26] is a bearing to take up radial forces on the shaft. [28] is a pathway for the first and last needle bearing. This part is inserted into the stator after the coils are winded.

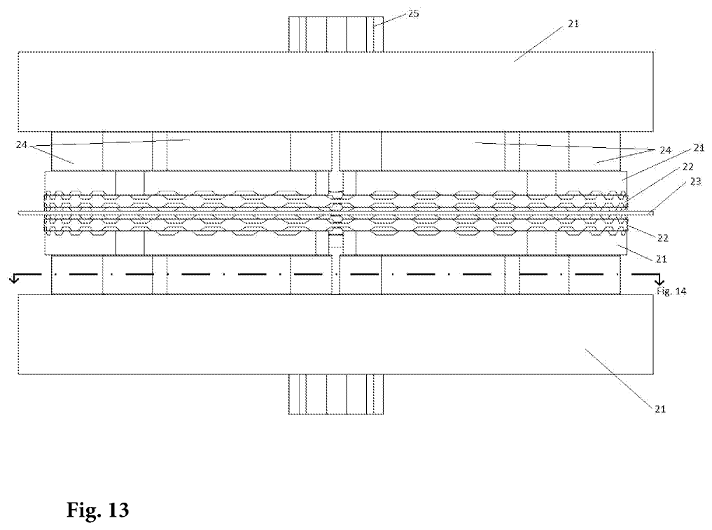

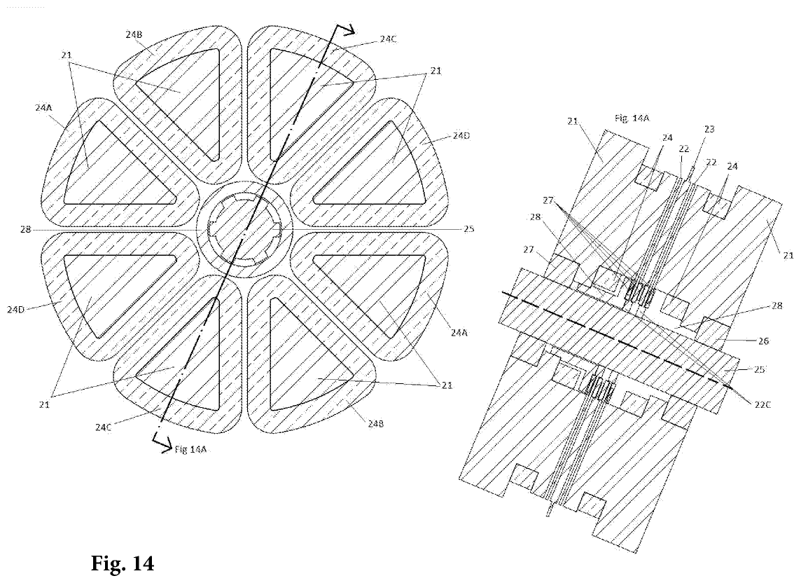

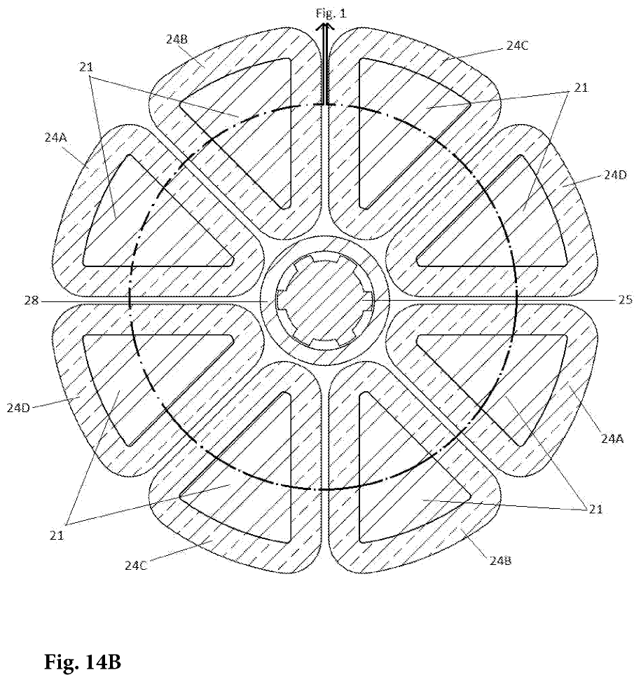

FIG. 13 shows the motor assembled, including the cross section for FIG. 14. The cross section is taken through the coils, so FIG. 14 shows the outline of the coils. FIG. 14 also has a cross section through the shaft. FIG. 14B shows the path for a circular cross section indicated by a dotted line. This cross section corresponds to FIG. 1 if an extra stator and rotor plate are added to the axial motor.

As mentioned in the introduction, reluctance motors with 4, 6 or higher pair number of phases can be designed with low torque ripple. It turns out that the 6 phased reluctance motor can be modified so it can run on a 3 phased electrical grid. Both the 4 and 6 phased reluctance motor can be modified so it can be controlled with respectively 2 phased and 3 phased inverters.

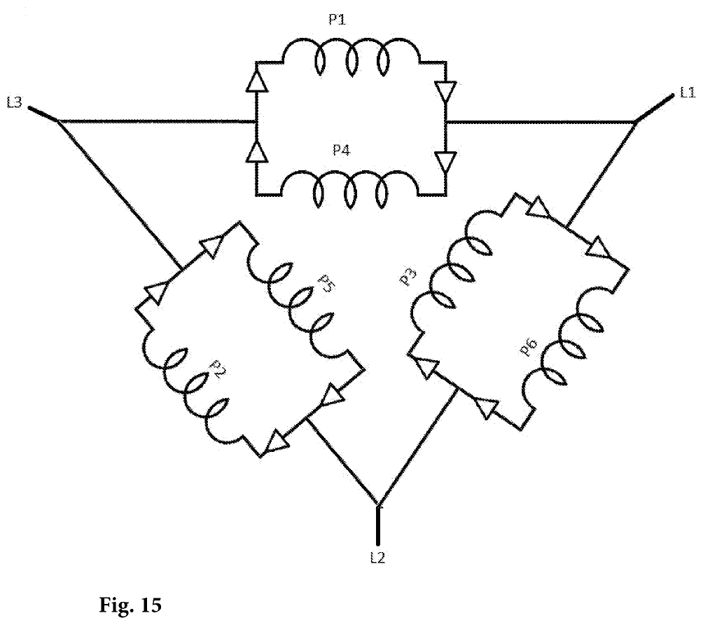

FIG. 15 shows how the phases in a 6-phased reluctance motor can be connected to a 3 phased grid in delta configuration by using 12 diodes. The diodes are organised so that the positive part of the current run through phase P1, P2 and P3 while the negative part of the current run through phase P4, P5 and P6. Star configuration based on the same principle is also possible. The principle can also be used to connect the motor to a 3 phased inverter or 3 full H-bridges. In similar way, a 4 phased reluctance motor can be controlled by a 2 phased inverter or 2 full H-bridges. This way controlling the 4 or 6 phased variable reluctance motor will be much the same as controlling 2 or 3 phased PM-motors.

The variable reluctance motor is a synchronous motor, meaning the motor must be spun up to synchronous speed before the motor is connected to the grid, if it shall run as a motor or generator without inverter.

1. A multiplate reluctance motor comprising a rotor and a stator, the stator comprising two end stators, wherein the two end stators comprise at least two coils per phase and end stator teeth, characterized by the stator further comprising at least one stator mid plate (4, 23) with stator mid plate teeth (13, 23A, 23B), wherein the at least one stator mid plate (4, 23) does not comprise coils, and the rotor comprising at least two rotor plates (3, 22) with rotor plate teeth (14, 22A, 22B), where the at least one stator mid plate (4, 23) and the at least two rotor plates (3, 22) are arranged between the two end stators (1, 21) providing for zigzagging of magnetic field (9) between the at least two rotor plates (3, 22) and the at least one stator mid plate (4, 23), thus amplifying torque of the reluctance motor.

2. The multiplate reluctance motor according to claim 1, comprising needle bearings for axial thrust arranged as spacers between at least two adjacent parts of the reluctance motor, where the parts comprise the end stators (1, 21), the stator mid plates (4, 23), and the rotor plates (3, 22), ensuring spacing between the adjacent parts.

3. The multiplate reluctance motor according to claim 1, comprising fluid bearings for axial thrust arranged as spacers between at least two adjacent parts of the reluctance motor, where the parts comprise the end stators (1, 21), the stator mid plates (4, 23) and the rotor plates (3, 22), ensuring spacing between the adjacent parts.

4. The multiplate reluctance motor according to claim 1, comprising bearing balls, where the rotor plates, the end stators and the stator mid plates are arranged with tracks for the bearing balls so the bearing balls can ensure distance between end stators (1, 21), stator mid plates (4, 23), and the rotor plates (3, 22), preventing them from touching each other.

5. The multiplate reluctance motor according to claim 1, wherein the number of phases being an even number equal to or greater than 4, and where the number of phases is halved by diodes arranged to steer the current into different phases depending on the direction of the current.

6. The multiplate reluctance motor according to claim 1, wherein the end stator teeth, stator mid plate teeth (13, 23A, 23B) and/or rotor plate teeth (14, 22A, 22B) having one of the following shapes: chamfered, filleted and sinusoidal.
